(19) United States
(12) Patent Application Publication
(10) Pub. No.: US 2008/0186420 A1
(43) Pub. Date: Aug. 7, 2008

(54) Liquid crystal display device and electronic apparatus including the same

(75) Inventors: Hidemasa Yamaguchi, Kanagawa (JP); Hironao Tanaka, Kanagawa (JP); Koji Noguchi, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION

(21) Appl. No.: 12/008,803

(22) Filed: Jan. 14, 2008

(30) Foreign Application Priority Data
Feb. 6, 2007 (JP) P2007-026852

(51) Int. Cl. G02F 1/133; G02F 1/1333

(52) U.S. Cl. 349/33; 349/114; 349/168

(57) ABSTRACT

There is provided a liquid crystal display device in which a direction of an orientation axis of a liquid crystal changes based on an electric field component in a direction different from that of a normal to a principal surface of a substrate, the liquid crystal display device including: a transmitting portion and a reflecting portion disposed on the substrate; wherein a voltage applied to the liquid crystal in the transmitting portion is different from that applied to the liquid crystal in the reflecting portion.

### CROSS REFERENCES TO RELATED APPLICATIONS

The present invention contains subject matter related to Japanese Patent Application JP 2007-026852 filed in the Japan Patent Office on Feb. 6, 2007, the entire contents of which being incorporated herein by reference.

### BACKGROUND OF THE INVENTION

1. Field of the Invention

The present invention relates to a liquid crystal display device having a combination use of reflection type display and transmission type display, and an electronic apparatus including the same.

2. Description of the Related Art

The liquid crystal display devices are widely used as ones of various electronic apparatuses by taking an advantage of the features that each of them is of a thin-model type and consumes the less power.

For example, there are known electronic apparatuses, using the liquid crystal display devices, such as a notebook-sized personal computer, a display device for a car navigation, a personal digital assistant (PDA), a mobile phone, a digital camera, and a video camera.

Such liquid crystal display devices are roughly classified into a transmission type liquid crystal display device, and a reflection type liquid crystal display device. Here, the transmission type liquid crystal display device is such that the display is carried out by controlling transmission and shielding of a light from an internal light source called a backlight by using a liquid crystal panel. Also, the reflection type liquid crystal display device is such that an extraneous light such as a solar light is reflected by a reflecting plate, and the display is carried out by controlling transmission and shielding of the reflected light by using a liquid crystal panel.

In the case of the transmission type liquid crystal display device, the power consumption of the backlight occupies 50% or more of the entire power consumption, and thus it is difficult to reduce the power consumption. In addition, the transmission type liquid crystal display device involves such a problem that when an ambient light is bright, the display appears to be dark, which results in the visibility being reduced.

On the other hand, the reflection type liquid crystal display device is free from the problem that the power consumption increases because of no provision of the backlight. However, the reflection type liquid crystal display device involves such a problem that when the ambient light is dark, the visibility is extremely reduced.

In order to solve the problems that both the transmission type liquid crystal display device and the reflection type liquid crystal display device involve, a reflection and transmission combination use type liquid crystal display device is proposed in which both the transmission type display and the reflection type display are realized in one liquid crystal panel.

In this reflection and transmission combination use type liquid crystal display device, the display is carried out based on the reflection of the ambient light when the circumference is bright, while the display is carried out based on the light from the backlight when the circumference is dark.

In addition, recently, the reflection and transmission combination use type liquid crystal display device is used with the hope that the reflection display is secondarily used when the circumference is bright while the backlight is lighted on a steady basis to maintain the transmission type display, thereby preventing the reduction of the visibility in many cases.

Now, the various liquid crystal display devices each using a first switching method utilizing so-called lateral electric field switching or a second switching method generating a fringe field are proposed in order to ensure a wide viewing angle. These liquid crystal display devices, for example, are described in Patent Documents 1 to 5 of Japanese Patent Laid-Open Nos. 2003-344837, 2006-126551, 2005-338256, 2005-338258, and 2006-171376, and Non-Patent Document 1 of SID'05 Digest, p. 1848.

### SUMMARY OF THE INVENTION

In the liquid crystal display device set at a first switching mode, liquid crystal molecules are rotation-driven approximately in parallel with surfaces of two sheets of substrates based on ON/OFF of an electric field applied to the liquid crystal layer sandwiched between the two sheets of substrate, thereby displaying an image on a screen.

An optical structure in the liquid crystal display device set at such a first switching mode is as follows. That is to say, polarizing plates are disposed in a cross nicol state outside the respective substrates. Also, liquid crystal molecules are ideally rotation-driven by 45° so that an orientation axis of the liquid crystal molecules becomes parallel with a transmission axis of one polarizing plate in a state in which application of the electric field is OFF, while the orientation axis of the liquid crystal molecules becomes different in direction from the transmission axis of the one polarizing plate in a state in which application of the electric field is ON.

As a result, in the state in which the application of the electric field is OFF, the light made incident from the incidence side polarizing plate reaches the outgoing side polarizing plate without occurrence of a phase difference to be absorbed in the outgoing side polarizing plate, thereby carrying out black display.

On the other hand, in the state in which the application of the electric field is ON, the orientation axis of the liquid crystal molecules makes an angle of 45° with the transmission axis of the polarizing axis, so that a phase difference occurs in the light passing through the liquid crystal layer. Then, a thickness (cell gap) of the liquid crystal layer is adjusted so that the phase difference of λ/2 occurs in the light passing through the liquid crystal layer.

As a result, the light made incident from the incidence side polarizing plate passes through the liquid crystal layer to rotate by 90°, thereby turning into a linearly-polarized light. Thus, the resulting linearly-polarized light passes through the outgoing side polarizing plate, thereby carrying out white display.

In addition, in the liquid crystal display device 1 set at a second switching mode, as shown in FIG. 1, fine slits are formed in a pixel electrode 2. A common electrode 4 is disposed on the lower side of the pixel electrode 2 through an insulating film 3. Thus, the switching is carried out so that a direction of an orientation axis of the liquid crystal of a liquid crystal layer 5 changes by utilizing a leakage electric field from the slit portions of the pixel electrode 2.

However, in each of the first switching mode and the second switching mode, the black display is carried out in a state in which one polarizing plate of the two sheets of polarizing plates disposed in the cross nicol state is made to agree with the orientation axis of the liquid crystal molecules.

For this reason, in the case of the reflection and transmission combination use type liquid crystal display device described above, the white display is merely carried out in the phase of non-application of the voltage just by structuring a reflection display region by providing a reflecting plate between the outgoing side polarizing plate and the liquid crystal layer. As a result, the display cannot be adjusted to the black display in the transmission display region.

In order to solve this problem, some systems are proposed in Patent Documents 1 to 5.

Each of Patent Documents 1 and 2 discloses a technique for disposing a retardation plate over the entire surfaces of the transmission portion and the reflection portion.

However, the technique disclosed in each of Patent Documents 1 and 2 has a disadvantage that the black color is set off because the transmitting portion also needs to show the black display based on the phase difference between the retardation plate and the liquid crystal layer. In other words, there is the disadvantage that even when the black display is desired to be carried out, it cannot be obtained because the transmitting portion transmits the light.

In addition, the brightness of black depends on the magnitude of the phase difference between the retardation plate and the liquid crystal. As a result, the dispersion of the retardation plates, and the dispersion of thicknesses of the liquid crystal layers exert an influence on a visual quality. Consequently, it is difficult to stably mass-produce the liquid crystal display device.

In addition, the visual quality is greatly deteriorated by the ambient temperatures because a refractive index of the liquid crystal largely depends on the temperatures.

Moreover, with this technique, when black is desired to be displayed, the black cannot be actually displayed because the transmission cannot be suppressed over all the wavelengths. A contrast is given as one factor for determining the visual quality. In order to obtain the high contrast, the brightness in the phase of the black display needs to be suppressed as much as possible.

In addition, the provision of the retardation plate results in that an extra phase difference exists in a direction of a viewing angle so that the view angle characteristics of the transmitting portion are also reduced.

The performance requirement of the transmitting portion for the image quality is high, which causes a disadvantage that the precious transmissive image quality in the first switching mode and the second switching mode is reduced.

In addition, Patent Document 3 proposes the technique for carrying out orientation division for a reflecting portion and a transmitting portion, that is, changing an orientation direction of liquid crystals in the reflecting portion and the transmitting portion, thereby obtaining a semi-transmissive performance.

In this case, although the image quality reduction in the transmitting portion as caused with the technique disclosed in each of Patent Documents 1 and 2 is less, there is the necessity for dividing the orientation of the liquid crystal. As a result, the number of manufacturing processes remarkably increases.

In addition, it is very difficult to realize the technique for clearly dividing the orientation of the liquid crystal in the mass-production, including the reliability.

In addition, each of Patent Documents 4 and 5 proposes a technique for forming a retardation layer only in a reflecting portion.

In this case, some sort of patterning process having a micron-precision is required for forming the retardation layer only in the reflecting portion. It is very difficult to realize the technique with which the patterning can be performed with the micron-precision in terms of the mass-production similarly to the technique disclosed in Patent Document 3 because of the reduction in yields, and the cost-up due to the increase in the number of processes.

In the light of the foregoing, it is therefore desirable to provide a liquid crystal display device which is capable of being mass-produced in high yields without an necessary for an extra retardation layer or the like, and without causing an increase in cost, and suppressing deterioration of an image quality, and an electronic apparatus including the same.

In order to attain the desire described above, according to an embodiment of the present invention, there is provided a liquid crystal display device in which a direction of an orientation axis of a liquid crystal changes based on an electric field component in a direction different from that of a normal to a principal surface of a substrate, the liquid crystal display device including: a transmitting portion and a reflecting portion disposed on the substrate; in which a voltage applied to the liquid crystal in the transmitting portion is different from that applied to the liquid crystal in the reflecting portion.

According to another embodiment of the present invention, there is provided a liquid crystal display device in which a direction of an orientation axis of a liquid crystal changes based on an electric field component in a direction different from that of a normal to a principal surface of a substrate, the liquid crystal display device including: a first substrate; a second substrate; a transmitting portion and a reflecting portion disposed on the substrate; a liquid crystal layer disposed between the first substrate and the second substrate; a first polarizing plate and a second polarizing plate disposed in a cross nicol state; a transmitting portion electrode formed in the transmitting portion; and a reflecting portion electrode formed in the reflecting portion; in which relative voltages applied to the transmitting portion electrode and the reflecting portion electrode, respectively, are different from each other.

According to still another embodiment of the present invention, there is provided in an electronic apparatus including a liquid crystal display device; in which in the liquid crystal display device, a direction of an orientation axis of a liquid crystal changes based on an electric field component in a direction different from that of a normal to a principal surface of a substrate, a transmitting portion and a reflecting portion are disposed on the substrate, and a voltage applied to the liquid crystal in the transmitting portion is different from that applied to the liquid crystal in the reflecting portion.

According to the embodiments of the present invention, the voltage applied to the liquid crystal in the transmitting portion is different from that applied to the liquid crystal in the reflecting portion.

In this case, this system is identical to the transmission type first switching system, and thus with regard to the transmission characteristics, the image quality having the high contrast is obtained at the same wide viewing angle as that in the transmission type first switching system. The necessary and sufficient display is obtained as the reflection display as well. Consequently, the negative-positive reversal is prevented from occurring between the reflection and the transmission.

According to the present invention, the mass-production can be carried out in the high yields without the necessity for the extra retardation layer or the like, and without causing the increase in cost, and also the deterioration of the image quality can be suppressed.

### BRIEF DESCRIPTION OF THE DRAWINGS

FIG. 1 is a cross sectional view explaining a liquid crystal display device in the related art using a second switching system;

FIG. 2 is a block diagram showing a structure of a liquid crystal display device according to an embodiment mode of the present invention;

FIG. 3 is a cross sectional view of a reflection and transmission combination use type liquid crystal display device according to a first embodiment of the present invention;

FIGS. 4A and 4B are respectively views schematically showing states of voltages and a liquid crystal in a phase of black display when a first method is adopted, and states of the voltages and the liquid crystal in a phase of white display when the first method is adopted in the first embodiment of the present invention;

FIG. 5 is a circuit diagram showing an equivalent circuit of a pixel portion when the first method is adopted;

FIGS. 6A and 6B are respectively views schematically showing states of voltages and a liquid crystal in a phase of black display when a second method is adopted, and states of the voltages and the liquid crystal in a phase of white display when the second method is adopted in the first embodiment of the present invention;

FIGS. 7A and 7B are respectively circuit diagrams showing equivalent circuits of a pixel portion when a second method is adopted;

FIG. 8 is a cross sectional view of a reflection and transmission combination use type liquid crystal display device according to a second embodiment of the present invention;

FIGS. 9A and 9B are respectively views schematically showing states of voltages and a liquid crystal in a phase of black display when the first method is adopted, and states of the voltages and the liquid crystal in a phase of white display when the first method is adopted in the second embodiment of the present invention;

FIGS. 10A to 10G are respectively views showing examples of electronic apparatuses to which the liquid crystal display devices according to the first and second embodiments of the present invention are applied; and

FIG. 11 is a schematic view explaining that each of the liquid crystal display devices according to the first and second embodiments of the present invention contains module-shaped one as well having a sealed structure.

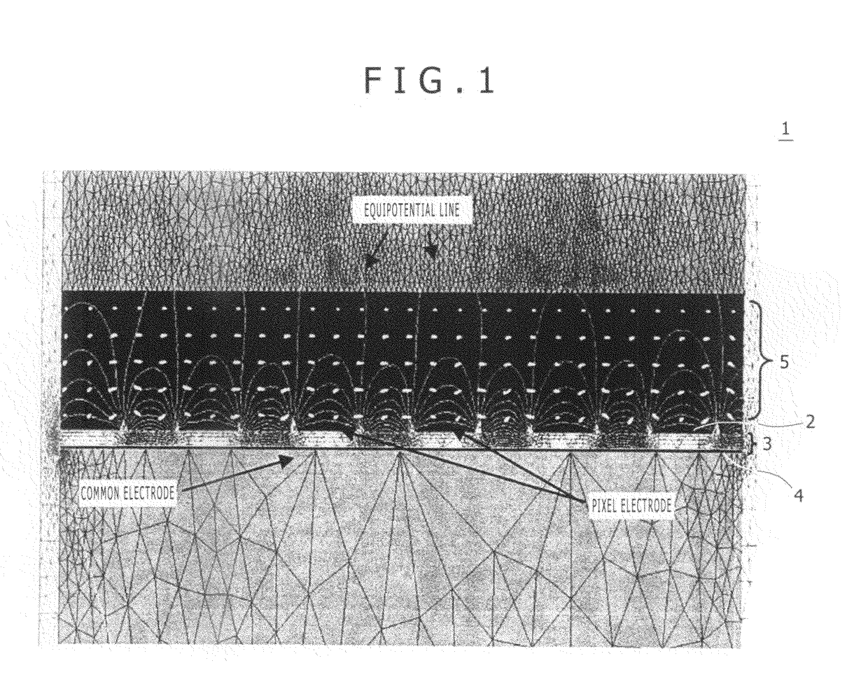

### DETAILED DESCRIPTION OF THE PREFERRED EMBODIMENTS

Preferred embodiments of the present invention will be described in detail hereinafter with reference to the accompanying drawings.

In the following description, firstly, embodiments with respect to concrete structures will be described in detail later after basic structure and function of a liquid crystal display device will now be described for the sake of facilitating the understanding of the present invention.

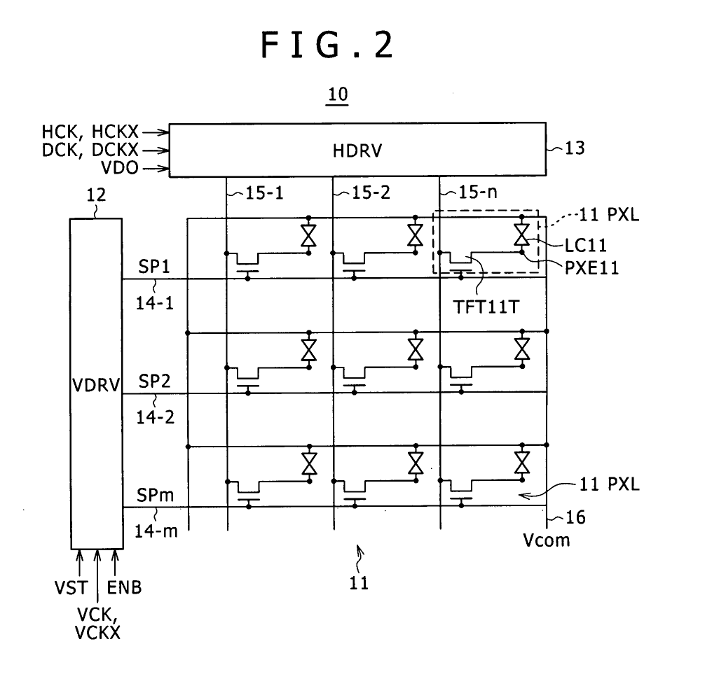

FIG. 2 is a block diagram showing a structure of a liquid crystal display device according to an embodiment mode of the present invention.

As shown in FIG. 2, a liquid crystal display device 10 includes an effective pixel region portion 11, a vertical driving circuit (VDRV) 12, and a horizontal driving circuit (HDRV) 13.

A plurality of pixel portions 11PXL are disposed in matrix in the effective pixel region portion 11.

Each of the pixel portions 11PXL is composed of a thin film transistor (TFT) as a switching element, and a liquid crystal cell LC11 having a pixel electrode PXE11 connected to a drain electrode (or a source electrode) of the TFT 11T.

For these pixel portions 11PXL, scanning lines 14-1 to 14-m are wired along a pixel disposition direction so as to correspond to respective rows, respectively, and signal lines 15-1 to 15-n are wired along a pixel disposition direction so as to correspond to respective columns, respectively.

In addition, gate electrodes of the TFTs 11T in the respective pixel portions 11PXL are connected to the same scanning lines (gate lines) 14-1 to 14-m in units of rows, respectively. Also, source electrodes (or drain electrodes) of the TFTs 11T in the respective pixel portions 11PXL are connected to the same signal lines 15-1 to 15-n in units of columns, respectively.

In addition, for example, a predetermined direct current (DC) voltage is applied as a common voltage Vcom to each of common electrodes of the liquid crystal cells LC11 in the respective pixel portions 11PXL through a common wiring.

Or, the common voltage Vcom a polarity of which, for example, is inverted every one horizontal scanning time period (1 H) is applied to each of the common electrodes of the liquid crystal cells LC11 in the respective pixel portions 11PXL.

Each of the scanning lines 14-1 to 14-m is driven by the vertical driving circuit 12, and each of the signal lines 15-1 to 15-n is driven by the horizontal driving circuit 4.

The TFT 11T is the switching element through which a display signal is supplied to each of the pixel regions of the pixels selected for display.

The TFT 11T, for example, has either a bottom-gate structure or a top-gate structure.

The vertical driving circuit 12 executes processing for successively scanning the scanning lines 14-1 to 14-m in a vertical direction (row direction) every one field time period by receiving as its inputs a vertical start signal VST, a vertical clock VCK, and an enable signal ENB, thereby successively selecting the pixel portions 11PXL connected to the scanning lines 14-1 to 14-m, respectively, in units of rows.

That is to say, when the vertical driving circuit 12 supplies a scanning pulse SP1 to the scanning line 14-1, the pixels in the columns belonging to the first row are selected. When the vertical driving circuit 12 supplies a scanning pulse SP2 to the scanning line 14-2, the pixels in the columns belonging to the second row are selected. Similarly, the vertical driving circuit 12 successively supplies scanning pulses SP3, . . . , SPm to the scanning lines 14-3, . . . , 14-m, respectively.

The horizontal driving circuit 13 generates scanning pulses by receiving as its inputs a horizontal start pulse HST which is generated by a clock generator (not shown) and which instructs start of the horizontal scanning, and horizontal clocks HCK and HCKX, as a reference for the horizontal scanning, which are in opposite phase with each other. In addition, the horizontal driving circuit 13 supplies image data R(red), G(green), and B(blue) inputted thereto as a data signal to be written to each of the pixel portions 11PXL to each of the signal lines 15-1 to 15-n by successively performing the sampling in response to the sampling pulses thus generated.

In the liquid crystal display device 10 described above, the TFT 11T of the pixel portion 11PXL is formed in the form of a semiconductor thin film transistor constituted by a semiconductor material such as amorphous silicon (a-Si) or polycrystalline silicon.

It is noted that the liquid crystal display device of this embodiment mode is structured in the form of the reflection and transmission combination use type liquid crystal display device, each of the pixel portions has a function of changing a direction of an orientation axis of a liquid crystal based on an electric field component in a direction different from that of a normal to a principal surface of a substrate, a transmitting portion and a reflecting portion are disposed in parallel with each other on the substrate, and a voltage applied to the liquid crystal in the transmitting portion is different from that applied to the liquid crystal in the reflecting portion.

As will be described later, a constitution can be adopted as a first basic constitution in correspondence to the constitution described above such that each of the pixel portions 11PXL has one TFT 11T as the switching element similarly to the case of FIG. 2, a common voltage is applied to each of a transmitting portion pixel electrode in the transmitting portion, and a reflecting portion pixel electrode in the reflecting portion, and different voltages are applied to a transmitting portion common electrode and a reflecting portion common electrode, respectively.

In addition, a constitution can also be adopted as a second basic constitution such that each of the pixel portions 11PXL has two TFTs 11T as the switching elements unlike the case of FIG. 2, a common voltage is applied to each of a transmitting portion common electrode and a reflecting portion common electrode, and different voltages are applied to a transmitting portion pixel electrode and a reflecting portion pixel electrode, respectively. In the case of the second basic constitution, with regard to the signal lines 15-1 to 15-n, two signal lines are wired every column. Alternatively, a constitution may also be adopted such that one signal line is wired every column, and with regard to the gate lines 14-1 to 14-m, two gate lines for the reflecting portion and the transmitting portion are wired every row.

In addition, the liquid crystal display device 10 of this embodiment mode can be mass-produced in high yields without the necessity for the extra retardation layer or the like, and without causing the increase in cost, and can suppress the deterioration of the image quality.

Hereinafter, concrete structures of the pixel portion of the liquid crystal display device 10 according to the embodiment mode of the present invention.

### First Embodiment

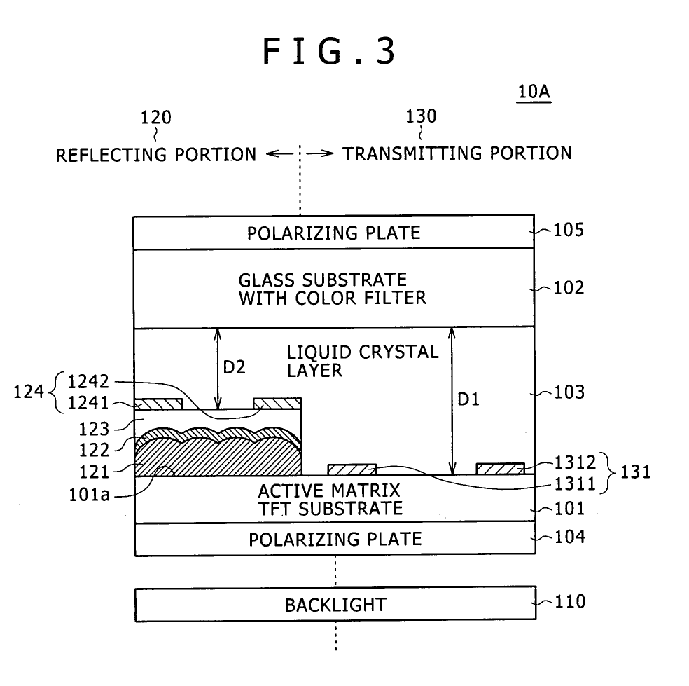

FIG. 3 is a cross sectional view of a reflection and transmission combination use type liquid crystal display device according to a first embodiment of the present invention.

A liquid crystal display device 10A according to a first embodiment of the present invention basically includes a first transparent substrate 101, a second transparent substrate 102, a liquid crystal layer 103, a first polarizing plate 104, a second polarizing plate 105, and a backlight 110 as main constituent elements.

In the liquid crystal display device 10A of the first embodiment, the liquid crystal layer 103 containing a plurality of liquid crystal molecules is basically disposed between the first transparent substrate 101 and the second transparent substrate 102. In other words, the liquid crystal layer 103 is sandwiched between the first transparent substrate 101 and the second transparent substrate 102.

In the liquid crystal display device 10A, a reflecting portion 120 and a transmitting portion 130 are formed in parallel with each other. Also, a thickness (first liquid crystal thickness: first inter-substrate gap) of the liquid crystal layer 103 in the transmitting portion 130 is set as D1, and a thickness (second liquid crystal thickness: second inter-substrate gap) of the liquid crystal layer 103 in the reflecting portion 120 is set as D2.

The liquid crystal display device 10A, as shown in FIG. 3, is structured so as to fulfill a relationship of D1>D2.

Each of the first transparent substrate 101 and the second transparent substrate 102 is constituted by a transparent insulating substrate, for example, made of a glass.

While not illustrated in FIG. 3, signal lines, gate lines and TFT elements are disposed in matrix on the first transparent substrate 101, thereby structuring an active matrix type liquid crystal display device.

A scatter layer 121 is formed in a region, on the first transparent substrate 101, in which the reflecting portion 120 is formed. A reflecting plate 122 made of Al or the like is formed on the scatter layer 121, and a transmissive flattened film 123 is formed on the reflecting plate 122. Also, a reflecting portion electrode 124 is formed on the transmissive flattened film 123.

In addition, the reflecting portion electrode 124 includes a reflecting portion pixel electrode 1241 and a common electrode 1242 for reflection.

A transmitting portion electrode 131 is formed in a region, on the first transparent substrate 101, in which the transmitting portion 130 is formed.

In addition, the transmitting portion electrode 131 includes a transmitting portion pixel electrode 1311, and a common electrode 1312 for transmission.

Each of the reflecting portion electrode 124 and the transmitting portion electrode 131 is made of an ITO or the like. Relatively different voltages are applied to the reflecting portion electrode 124 and the transmitting portion electrode 131, respectively.

With regard to a method of applying the relatively different voltages to the reflecting portion electrode 124 and the transmitting portion electrode 131, respectively, two methods can be adopted as follows.

With a first method, a common voltage (for example, 0 V or 5 V) is applied to each of the reflecting portion pixel electrode 1241 and the transmitting portion pixel electrode 1311. Also, different voltages (for example, 0 V and 5 V) are applied to the reflecting portion common electrode 1242 and the transmitting portion common electrode 1312, respectively.

With a second method, a common voltage (for example, 0V or 5 V) is applied to each of the reflecting portion common electrode 1242 and the transmitting portion common electrode 1312. Also, different voltages (for example, 0 V and 5 V) are applied to the reflecting portion pixel electrode 1241 and the transmitting portion pixel electrode 1311, respectively.

As has been described above, the liquid crystal display device 10A of this embodiment is structured such that the voltage applied to the liquid crystal in the reflecting portion 120, and the voltage applied to the liquid crystal in the transmitting portion 130 are different from each other.

The liquid crystal display device 10A is basically controlled such that in a phase of black display, a voltage equal to or higher than a threshold value at which a change in orientation of the liquid crystal occurs is applied to the reflecting portion 120, and either a voltage equal to or lower than the threshold value or no voltage is applied to the transmitting portion 130.

On the other hand, the liquid crystal display device 10A is basically controlled such that the voltage equal to or higher than the threshold value at which the change in orientation of the liquid crystal occurs is applied to the transmitting portion 130, and either the voltage equal to or lower than the threshold value or no voltage is applied to the reflecting portion 120.

In the liquid crystal display device 10A of the first embodiment, the first polarizing plate 104 and the second polarizing plate 105 are disposed in a cross nicol state outside principal surfaces 101a and 102a of the first transparent substrate 101 and the second transparent substrate 102, respectively, in a direction (a direction of lamination of the layers) of a normal v to each of the principal surfaces 101a and 102a of the first transparent substrate 101 and the second transparent substrate 102.

In such a structure, in the phase of the black display, the direction of the orientation of the liquid crystal in the transmitting portion 130 agrees with a direction of an absorption axis of one of the first polarizing plate 104 and the second polarizing plate 105. In addition, the direction of the orientation of the liquid crystal in the reflecting portion 120 is different from that of each of the absorption axes of the first polarizing plate 104 and the second polarizing plate 105.

On the other hand, in the phase of the white display, the direction of the orientation of the liquid crystal in the reflecting portion 120 agrees with that of the absorption axis of one of the first polarizing plate 104 and the second polarizing plate 105. In addition, the direction of the orientation of the liquid crystal in the transmitting portion 130 is different from that of each of the absorption axes of the first polarizing plate 104 and the second polarizing plate 105.

In addition, in the phase of the black display, the orientation of the liquid crystal layer 103 in the reflecting portion 120 has a function of shifting a phase of a linearly-polarized light by about λ/4.

With halftone display is desired to be carried out, the suitable voltages may be applied to the liquid crystal in the reflecting portion 120 and the liquid crystal in the transmitting portion 130, respectively, so as to obtain the halftone between black and white.

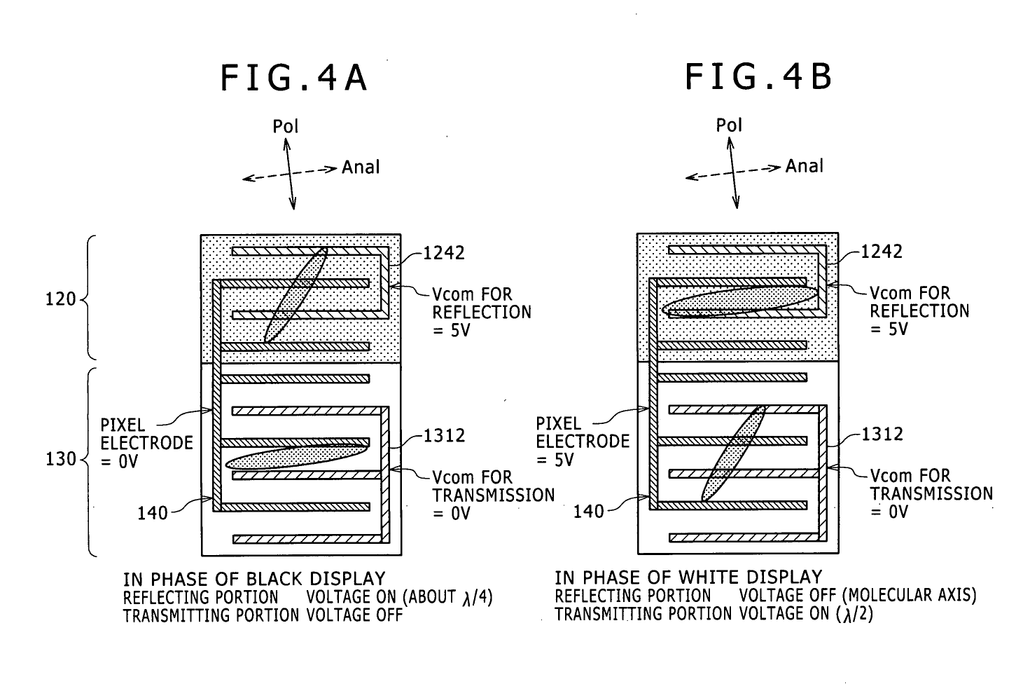

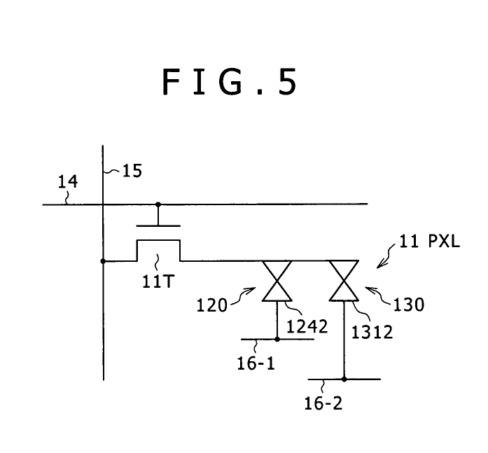

FIGS. 4A and 4B are respectively views schematically showing states of voltages and the liquid crystal in the phase of black display when the first method is adopted, and states of the voltages and the liquid crystal in the phase of the white display when the first method is adopted in the first embodiment of the present invention. Also, FIG. 5 is a circuit diagram showing an equivalent circuit of the pixel portion when the first method is adopted.

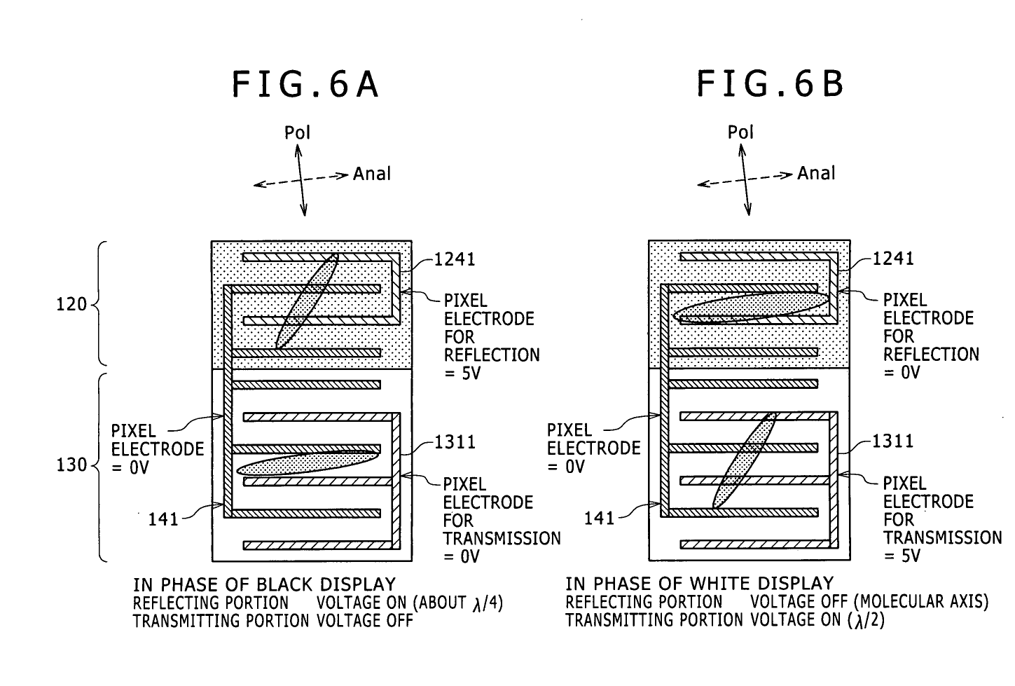

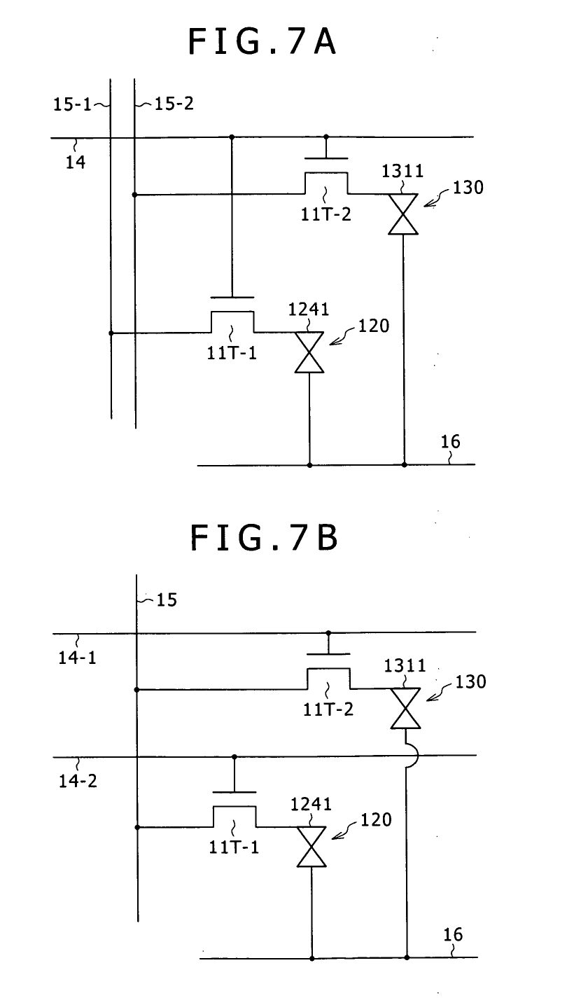

FIGS. 6A and 6B are respectively views schematically showing states of voltages and the liquid crystal in the phase of the black display when the second method is adopted, and states of the voltages and the liquid crystal in the phase of the white display when the first method is adopted in the second embodiment of the present invention. FIGS. 7A and 7B are respectively circuit diagrams showing equivalent circuits of the pixel portion when the second method is adopted.

In the structures shown in FIGS. 4A and 4B, and FIG. 5, the reflecting portion pixel electrode 1241 and the transmitting portion pixel electrode 1311 are connected to each other to form a shared pixel electrode 140. In addition, a common voltage (of 0 V or 5 V) is applied to the shared pixel electrode 140, and different voltages (of 0 V and 5 V) are applied to the reflecting portion common electrode 1242 and the transmitting portion common electrode 1312, respectively.

More specifically, in the phase of the black display, as shown in FIG. 4A, a voltage of 0 V is applied to the pixel electrode 140. A voltage of 0 V is applied to the transmitting portion common electrode 1312, and a voltage of 5 V is applied to the reflecting portion common electrode 1242. As a result, in the reflecting portion 120, an electric field component in a direction different from that of the normal to each of the principal surfaces of the first and second transparent substrates 101 and 102 changes the direction of the orientation axis of the liquid crystal.

On the other hand, in the phase of the white display, as shown in FIG. 4B, a voltage of 5 V is applied to the pixel electrode 140. A voltage of 0 V is applied to the transmitting portion common electrode 1312, and a voltage of 5 V is applied to the reflecting portion common electrode 1242. As a result, in the transmitting portion 130, the electric field component in the direction different from that of the normal to each of the principal surfaces of the first and second transparent substrates 101 and 102 changes the direction of the orientation axis of the liquid crystal.

In the structures shown in FIGS. 6A and 6B, and FIGS. 7A and 7B, the reflecting portion common electrode 1242 and the transmitting portion common electrode 1312 are connected to each other to form a shared common electrode 141. In addition, a common voltage (of 0 V or 5 V) is applied to the shared common electrode 141, and different voltages (of 0 V and 5 V) are applied to the reflecting portion pixel electrode 1241 and the transmitting portion pixel electrode 1311, respectively.

More specifically, in the phase of the black display, as shown in FIG. 6A, a voltage of 0 V is applied to the common electrode 141, a voltage of 0 V is applied to the transmitting portion pixel electrode 1311, and a voltage of 5 V is applied to the reflecting portion pixel electrode 1241. As a result, in the reflecting portion 120, an electric field component in a direction different from that of the normal to each of the principal surfaces of the first and second transparent substrates 101 and 102 changes the direction of the orientation axis of the liquid crystal.

On the other hand, in the phase of the white display, as shown in FIG. 6B, a voltage of 0 V is applied to the common electrode 141, a voltage of 5 V is applied to the transmitting portion pixel electrode 1311, and a voltage of 0 V is applied to the reflecting portion pixel electrode 1241. As a result, in the transmitting portion 130, an electric field component in a direction different from that of the normal to each of the principal surfaces of the first and second transparent substrates 101 and 102 changes the direction of the orientation axis of the liquid crystal.

The structure and function of the liquid crystal display device 10 according to the first embodiment of the present invention will be further described in detail hereinafter with reference to FIGS. 4A and 4B to FIGS. 7A and 7B.

As shown in FIGS. 4A and 4B, and FIGS. 6A and 6B, each of the pixel electrode the voltage at which changes depending on the signal inputted thereto, and the common electrode is formed into a comb-like shape on the surface of the TFT substrate 101. Thus, the electric field component (containing the electric field component of the electric field which is approximately parallel with each of the first and second transparent substrates 101 and 102) in the direction different from that of the normal to each of the principal surfaces of the first and second transparent substrates 101 and 102) is applied to each of the pixel electrode and the common electrode.

As described above, the first and second polarizing plates 104 and 105 are disposed in the cross nicol state. Thus, in the phase of application of no voltage, the liquid crystal shows a homogeneous orientation, and the direction of the homogeneous orientation agrees with the direction of the transmission axis of one of the first and second polarizing plates 104 and 105.

In the phase of the back display, as shown in FIG. 4A and FIG. 6A, the voltage applied to the transmitting portion 130 is either 0 V or a voltage at which no orientation of the liquid crystal changes. Thus, the voltage concerned is in a so-called OFF state. In the transmitting portion 130, the axis of the liquid crystal and the axis of the first polarizing layer 104 agree with each other. Therefore, the polarization state of the light which the first polarizing plate 104 transmits does not change in the liquid crystal layer 103, and the polarized light is absorbed in the second polarizing plate 105.

On the other hand, as shown in FIG. 4A and FIG. 6A, the voltage equal to or higher than the threshold value which gives a change in orientation of the liquid crystal is applied to the reflecting portion 120. As a result, the average orientation axis of the liquid crystal, as shown in these figures, rotates by about 45°. The actual liquid crystal orientation is mixed with a twist. Therefore, there is no problem as long as such an orientation as to shift a phase by about λ/4 is obtained.

The extraneous light is converted into a linearly-polarized light in the second polarizing plate 105. The resulting linearly-polarized light shifts in its phase by about λ/4 in the liquid crystal layer 103 to turn into a circularly-polarized light. The resulting circularly-polarized light further shifts in its phase by λ/4 after being reflected by the reflecting plate 122. Finally, the circularly-polarized light is converted into a linearly-polarized light having the phase shift of λ/4 (rotation of 90°), and the resulting linearly-polarized light is absorbed by the second polarizing plate 105, thereby carrying out the black display.

In the phase of the white display, contrary to the phase of the black display, the voltage equal to or higher than the threshold value is applied to the transmitting portion 130, so that the polarized light changes in the liquid crystal layer 103 to permeate through the liquid crystal layer 103.

Only the voltage equal to or lower than the threshold value is applied to the reflecting portion 120. As a result, the axis of the liquid crystal, and the transmission axis of the polarizing plate 105 agree with each other, and thus the polarization state of the polarized light does not change in the liquid crystal layer 103. Therefore, the incident polarized light permeates through the liquid crystal layer 103, thereby carrying out the white display.

In order to realize such a driving operation, the adoption of the structures shown in FIGS. 4A and 4B, and FIG. 5 is more preferable than the adoption of the structures shown in FIGS. 6A and 6B, and FIGS. 7A and 7B.

In the structures shown in FIGS. 4A and 4B, and FIG. 5, as described above, the pixel electrode to which the voltages corresponding to the respective signals are applied is common to the reflecting portion 120 and the transmitting portion 130. Also, the common electrode is divided into the parts for the reflecting portion 120 and the transmitting portion 130.

The voltages applied to the common electrode 1312 in the transmitting portion 130, and the common electrode 1242 in the reflecting portion 120 are set as the relationship with Vsig in the transmitting portion 130 becomes opposite to the relationship with Vsig in the reflecting portion 120.

For example, this situation is given as follows:

transmitting portion VcomT=Vsig (black),

reflecting portion VcomR=Vsig (white)

where VcomT represents the common potential in the transmitting portion 130, VcomR represents the common potential in the reflecting portion 120, Vsig (black) represents a signal potential applied to the pixel in the phase of the black display, and Vsig (white) represents a signal potential applied to the pixel in the phase of the white display.

On the other hand, as shown in FIGS. 6A and 6B, and FIGS. 7A and 7B, the common electrode is made common to the reflecting portion 120 and the transmitting portion 130, and the pixel electrode is divided into parts for the reflecting portion 120 and the transmitting portion 130, thereby making it possible to realize the driving operation described above. Note, the complicated signal processing needs to be executed because the signal itself needs to be produced, and the pixel transistors need to be provided for both the reflection and the transmission, respectively, which exerts a large influence on the aperture ratio. Consequently, the first method as described above is more preferable than the second method.

### Second Embodiment

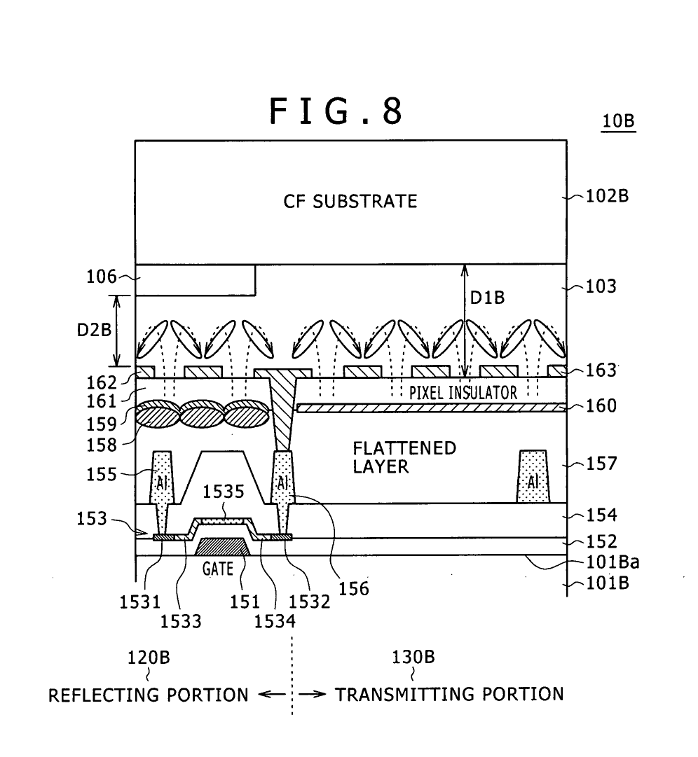

FIG. 8 is a cross sectional view of a reflection and transmission combination use type liquid crystal display device according to a second embodiment of the present invention.

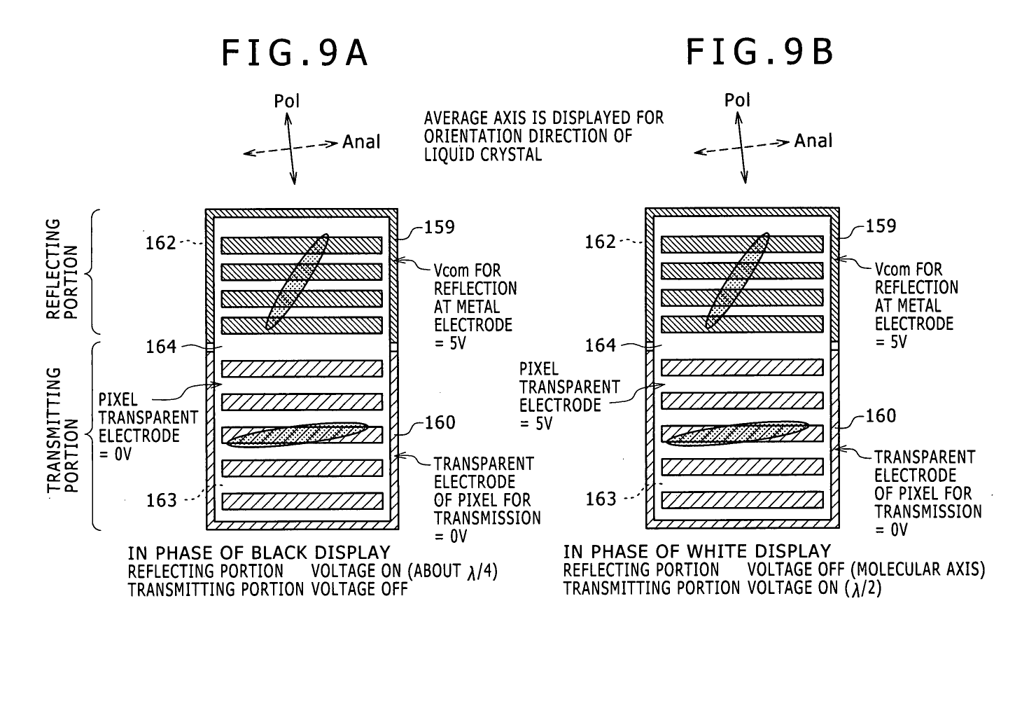

FIGS. 9A and 9B are respectively views schematically showing states of voltages and a liquid crystal in the phase of the black display when the first method is adopted, and states of the voltages and the liquid crystal in the phase of the white display when the first method is adopted in the second embodiment of the present invention.

The second embodiment of the present invention shows a structural example when the second switching system is utilized.

In the liquid crystal display device 10B of the second embodiment, the liquid crystal layer 103 containing a plurality of liquid crystal molecules is basically disposed between a first transparent substrate 101B and a second transparent substrate 102B. In other words, the liquid crystal layer 103 is sandwiched between a first transparent substrate 101B and a second transparent substrate 102B.

In the liquid crystal display device 10B, a reflecting portion 120B and a transmitting portion 130B are formed in parallel with each other. Also, a thickness (first liquid crystal thickness: first inter-substrate gap) of the liquid crystal layer 103 in the transmitting portion 130B is set as D1B, and a thickness (second liquid crystal thickness: second inter-substrate gap) of the liquid crystal layer 103 in the reflecting portion 120B is set as D2B.

In the liquid crystal display device 10B, as shown in FIG. 8, a step forming layer 106 for gap adjustment is formed on the second substrate 102B so as to fulfill a relationship of D1B>D2B.

A scanning line 151 (corresponding to the scanning line 14 shown in FIG. 2) corresponding to the gate electrode of the TFT 11T is formed on the reflecting portion 120B side on a first surface 101Ba facing the liquid crystal layer 103 of the first transparent substrate 101.

It is noted that the scanning wiring (gate electrode) 151 is formed by, for example, depositing a metal such as molybdenum (Mo) or tantalum (Ta) or an alloy by utilizing a sputtering method or the like.

An insulating film 152 functioning as a gate insulating film is formed so as to cover the scanning wiring 151 and the first surface 101Ba of the first transparent substrate 101B.

An n-type semiconductor layer 153 is formed in a region facing the scanning wiring (gate electrode) 151 on the insulating film 152. A source electrode portion (S) 1531 and a drain electrode portion (D) 1532 as n⁺-type diffusion layers, n⁻-type diffusion layers (LDD layers) 1533 and 1534, and a channel formation region 1535 are formed in the n-type semiconductor (thin film) layer 153.

The n-type semiconductor thin film layer 153 is made of a low-temperature polysilicon thin film which is formed by, for example, utilizing a CVD method.

An interlayer insulating film 154 is formed on the insulating film 152 and the n-type semiconductor layer 153. In addition, a signal wiring 155 (corresponding to the signal line 15 shown in FIG. 2), for example, made of aluminum (Al) is connected to the source electrode portion (S) 1531 through a contact hole. Also, a conductive portion (connection electrode) 156, made of Al, at the same level metallization as that of, for example, the signal wiring 155 is connected to the drain electrode portion 1532 through a contact hole.

Moreover, a flattened film 157 is formed on the signal wiring 155, the conductive portion 156, and the interlayer insulating film 154.

In addition, a reflecting portion common electrode 159 is formed on the flattened film 157 in the reflecting portion 120B through a scatter layer 158.

In addition, a transmitting portion common electrode 160 as a transparent electrode made of an ITO or the like is formed on the flattened film 157 in the transmitting portion 130.

Also, a pixel insulating film 161 is formed so as to cover the reflecting portion common electrode 159 and the transmitting portion common electrode 160, and a reflecting portion pixel electrode 162 and a transmitting portion pixel electrode 163 are formed on the pixel insulating film 161.

In this structure, as shown in FIGS. 9A and 9B, each of the reflecting portion pixel electrode 162 and the transmitting portion pixel electrode 163 has such a structure as to have slits formed therein, and the reflecting portion pixel electrode 162 and the transmitting portion pixel electrode 163 are connected to each other. In other words, a common voltage is applied to each of the reflecting portion pixel electrode 162 and the transmitting portion pixel electrode 163.

In addition, for example, the reflecting portion pixel electrode 162 is connected to the conductive portion 156 through the contact hole formed in the insulating films 157 and 161.

In the structures shown in FIG. 8, and FIGS. 9A and 9B, the reflecting portion pixel electrode 102 and the transmitting portion pixel electrode 163 are connected to each other to form a shared pixel electrode 164. Also, a common voltage (of 0 V or 5 V) is applied to the shared pixel electrode 164, and different voltages (of 0 V and 5 V) are applied to the reflecting portion common electrode 159 and the transmitting portion common electrode 160, respectively.

More specifically, in the phase of the black display, as shown in FIG. 9A, a voltage of 0 V is applied to the pixel electrode 164, a voltage of 0 V is applied to the transmitting portion pixel electrode 160, and a voltage of 5 V is applied to the reflecting portion common electrode 159. As a result, in the reflecting portion 120B, an electric field component in a direction different from that of the normal to each of the principal surfaces of the first and second transparent substrates 101B and 102B changes the direction of the orientation axis of the liquid crystal.

In the phase of the white display, as shown in FIG. 9B, a voltage of 5 V is applied to the pixel electrode 164, a voltage of 0 V is applied to the transmitting portion common electrode 160, and a voltage of 5 V is applied to the reflecting portion common electrode 159. As a result, in the transmitting portion 130B, an electric field component in a direction different from that of the normal to each of the principal surfaces of the first and second transparent substrates 101B and 102B changes the direction of the orientation axis of the liquid crystal.

In this case, the orientation of the liquid crystal is changed by utilizing an oblique electric filed in the slits of the pixel electrode. The principles of the display are the same as those in the case of switching (so-called transverse electric field switching) based on the electric field component (containing the electric field component which is approximately parallel with the substrate) of the electric field in the direction different from that of the normal to each of the principal surfaces of the first and second transparent substrates 101B and 102B in the first embodiment described above.

In addition, since the reflecting plate can be shared with the common electrode 159 for the reflecting portion, the number of processes can be reduced as compared with the case of the first embodiment, and the aperture ratio can be set as being larger in the fringe-field switching (FFS) than in the other system. Thus, many merits can be obtained, and this structure is more preferable than in the first embodiment.

As has been described so far, according to the first and second embodiments of the present invention, when attention is paid only to the transmitting portion, this switching system is identical to the transmission type first switching system. Thus, with regard to the transmission characteristics, the image quality having the high-contrast can be obtained at the same wide viewing angle as that in the transmission type first switching system. In addition, the necessary and sufficient display is obtained as the reflection display. Therefore, there is caused no problem that the negative-positive reversal occurs between the reflection and the transmission.

In addition, according to the first and second embodiments of the present invention, the inexpensive liquid crystal display device can be manufactured only by performing the patterning on the active matrix side, and can be mass-produced in the high yield without the necessity for provision of the extra retardation layer or the like.

Furthermore, the active matrix type display device typified by the active matrix type liquid crystal displays according to the first and second embodiments of the present invention is used as the display device for use in OA equipment such as a personal computer or a word processor, or a television receiver. In addition thereto, especially, the active matrix type display device is suitably used as a display portion of an electronic apparatus such as a mobile phone or a PDA for which the miniaturization and compactness of the apparatus main body progress.

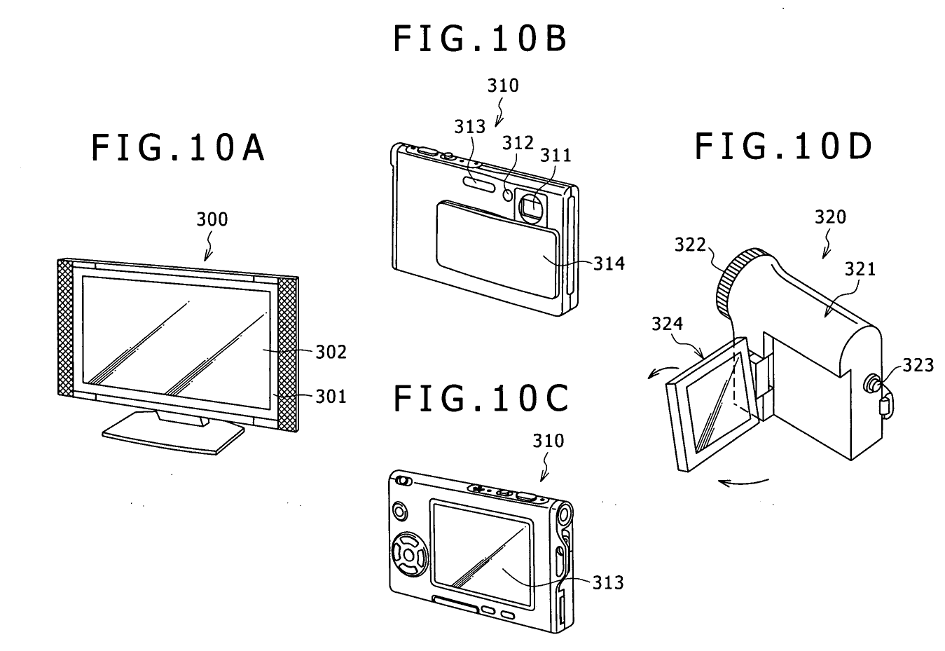

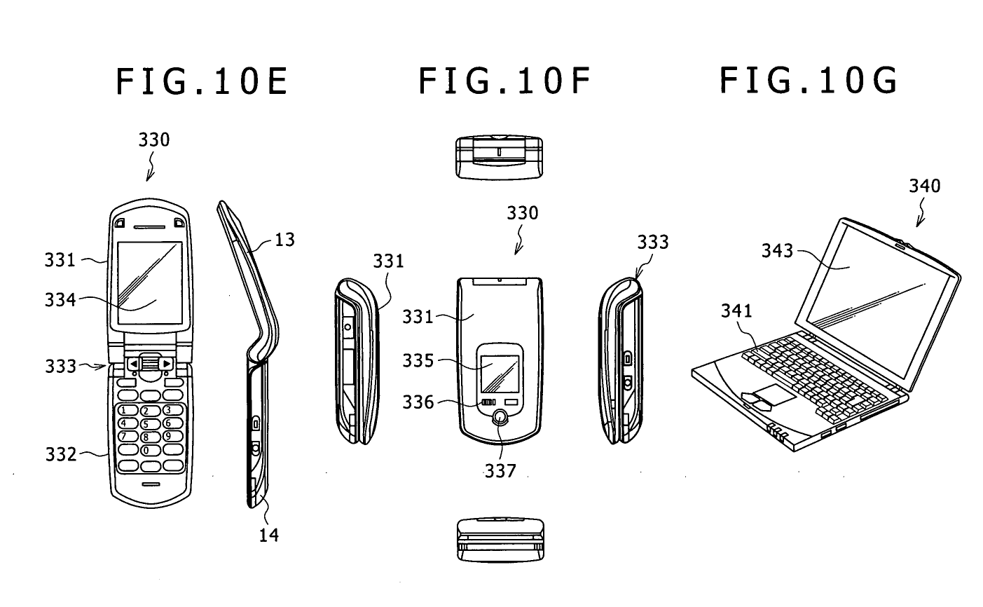

That is to say, the liquid crystal display device 10 of the embodiment mode, and the liquid crystal display devices 10A and 10B of the first and second embodiments can be applied to the display devices, of the electronic apparatuses in all the fields, for displaying thereon an image or a video picture corresponding to the video signal which is inputted to or generated in the electronic apparatus. In this case, the electronic apparatus is typified by the various electronic apparatuses, shown in FIGS. 10A to 10G, such as a digital camera, a notebook-sized personal computer, a mobile phone, and a video camera.

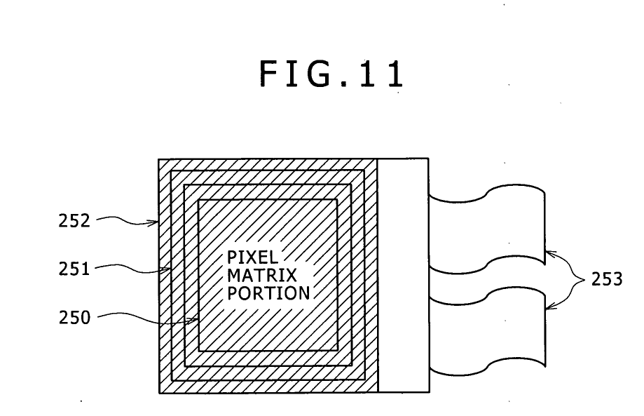

It is noted that the liquid crystal display devices according to the first and second embodiments of the present invention contain module-shaped one as well having a sealed structure as shown in FIG. 11.

For example, a display module which is formed by sticking a sealing portion 251 to a transparent counter portion 252 made of a glass or the like by using an adhesive agent corresponds to the module-shaped liquid crystal display device as shown in FIG. 11. Here, the sealing portion 251 is provided so as to surround a pixel array portion (effective display region) 250.

The transparent counter portion 252 may be provided with a color filter, a protective film, a light shielding film, and the like. It is noted that this display module may be provided with a flexible printed circuit (EPC) 253 for receiving and outputting a signal or the like to the pixel array portion 250 from and to the outside.

Hereinafter, examples of the electronic apparatuses to each of which such a display device is applied will be shown.

FIG. 10A shows an example of a television 300 to which the present invention is applied. This television 300 includes an image display screen 303 composed of a front panel 301, a filter glass 302 and the like. Also, this television 300 is manufactured by using the liquid crystal display device according to one of the first and second embodiments of the present invention in the image display screen 303.

FIGS. 10B and 10C show an example of a digital camera 310 to which the present invention is applied. The digital camera 310 includes an imaging lens 311, a light emitting portion 312 for flash, a display portion 313, a control switch 314, and the like. Also, the digital camera 310 is manufactured by using the liquid crystal display device according to one of the first and second embodiments of the present invention in the display portion 313.

FIG. 10D shows a video camera 320 to which the present invention is applied. The video camera 320 includes a main body portion 321, a subject photographing lens 322 provided on an anteriorly-directed side surface, a start/stop switch 323 which is manufactured in a phase of photographing, a display portion 324, and the like. Also, the video camera 320 is manufactured by using the liquid crystal display device according to one of the first and second embodiments of the present invention in the display portion 324.

FIGS. 10E and 10F show a mobile terminal 330 to which the present invention is applied. The mobile terminal 330 includes an upside chassis 331, a downside chassis 332, a connection portion (a hinge portion in this example) 333, a display 334, a sub-display 335, a picture light 336, a camera 337, and the like. Also, the mobile terminal 330 is manufactured by using the liquid crystal display device according to one of the first and second embodiments of the present invention in the display 334 and/or the sub-display 335.

FIG. 10G shows a notebook-sized personal computer 340 to which the present invention is applied. The notebook-sized personal computer 340 includes a main body 341, a keyboard 342 which is manufactured when characters or the like are inputted, a display portion 343 which displays thereon an image, and the like. Also, the notebook-sized personal computer 340 is manufactured by using the liquid crystal display device according to one of the first and second embodiments of the present invention in the display portion 343.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device in which a direction of an orientation axis of a liquid crystal changes based on an electric field component in a direction different from that of a normal to a principal surface of a substrate, said liquid crystal display device comprising:
a transmitting portion and a reflecting portion disposed on said substrate;
wherein a voltage applied to the liquid crystal in said transmitting portion is different from that applied to the liquid crystal in said reflecting portion.

2. The liquid crystal display device according to claim 1, wherein in a phase of black display, a voltage equal to or higher than a threshold value at which an orientation of the liquid crystal changes is applied to said reflecting portion, and either a voltage equal to or lower than the threshold value or no voltage is applied to said transmitting portion.

3. The liquid crystal display device according to claim 1, wherein in a phase of white display, a voltage equal to or higher than a threshold value at which an orientation of the liquid crystal changes is applied to said transmitting portion, and either a voltage equal to or lower than the threshold value or no voltage is applied to said reflecting portion.

4. The liquid crystal display device according to claim 1, wherein in a phase of black display, a voltage equal to or higher than a threshold value at which an orientation of the liquid crystal changes is applied to said reflecting portion, and either a voltage equal to or lower than the threshold value or no voltage is applied to said transmitting portion, while in a phase of black display, a voltage equal to or higher than the threshold value is applied to said transmitting portion, and either a voltage equal to or lower than the threshold value or no voltage is applied to said reflecting portion.

5. The liquid crystal display device according to claim 2, wherein a first polarizing plate and a second polarizing plate are disposed in a cross nicol state,
in the phase of the black display, a direction of the orientation of the liquid crystal in said transmitting portion agrees with a direction of an absorption axis of one of said first polarizing plate and said second polarizing plate, and
a direction of the orientation of the liquid crystal in said reflecting portion is different from each of directions of the absorption axes of said first polarizing plate and said second polarizing plate.

6. The liquid crystal display device according to claim 3, wherein a first polarizing plate and a second polarizing plate are disposed in a cross nicol state,
in the phase of the white display, a direction of the orientation of the liquid crystal in said reflecting portion agrees with a direction of an absorption axis of one of said first polarizing plate and said second polarizing plate, and
a direction of the orientation of the liquid crystal in said transmitting portion is different from each of directions of the absorption axes of said first polarizing plate and said second polarizing plate.

7. The liquid crystal display device according to claim 4, wherein a first polarizing plate and a second polarizing plate are disposed in a cross nicol state,
in the phase of the black display, a direction of the orientation of the liquid crystal in said transmitting portion agrees with a direction of an absorption axis of one of said first polarizing plate and said second polarizing plate, and
a direction of the orientation of the liquid crystal in said reflecting portion is different from each of directions of the absorption axes of said first polarizing plate and said second polarizing plate,
while in the phase of the white display, a direction of the orientation of the liquid crystal in said reflecting portion agrees with a direction of an absorption axis of one of said first polarizing plate and said second polarizing plate, and
a direction of the orientation of the liquid crystal in said transmitting portion is different from each of directions of the absorption axes of said first polarizing plate and said second polarizing plate.

8. The liquid crystal display device according to claim 7, wherein in the phase of the black display, the liquid crystal layer in said reflecting portion delays a phase of a linearly-polarized light by λ/4.

9. The liquid crystal display device according to claim 1, wherein said substrate includes a first substrate and a second substrate, the liquid crystal is disposed between said first substrate and said second substrate, a transmitting portion electrode is formed in said transmitting portion, a reflecting portion electrode is formed in said reflecting portion, and relative voltages applied to said transmitting portion electrode and said reflecting portion electrode, respectively, are different from each other.

10. The liquid crystal display device according to claim 9, wherein said transmitting portion electrode includes a transmitting portion pixel electrode and a transmitting portion common electrode, said reflecting portion electrode includes a reflecting portion pixel electrode and a reflecting portion common electrode, a common voltage is applied to each of said transmitting portion pixel electrode and said reflecting portion pixel electrode, and different voltages are applied to said transmitting portion common electrode and said reflecting portion common electrode, respectively.

11. The liquid crystal display device according to claim 9, wherein said transmitting portion electrode includes a transmitting portion pixel electrode and a transmitting portion common electrode, said reflecting portion electrode includes a reflecting portion pixel electrode and a reflecting portion common electrode, a common voltage is applied to each of said transmitting portion common electrode and said reflecting portion common electrode, and different voltages are applied to said transmitting portion pixel electrode and said reflecting portion pixel electrode, respectively.

12. A liquid crystal display device in which a direction of an orientation axis of a liquid crystal changes based on an electric field component in a direction different from that of a normal to a principal surface of a substrate, said liquid crystal display device comprising:
a first substrate;
a second substrate;
a transmitting portion and a reflecting portion disposed on said substrate;
a liquid crystal layer disposed between said first substrate and said second substrate;
a first polarizing plate and a second polarizing plate disposed in a cross nicol state;
a transmitting portion electrode formed in said transmitting portion; and
a reflecting portion electrode formed in said reflecting portion;
wherein relative voltages applied to said transmitting portion electrode and said reflecting portion electrode are different from each other.

13. An electronic apparatus comprising a liquid crystal display device;
wherein in said liquid crystal display device, a direction of an orientation axis of a liquid crystal changes based on an electric field component in a direction different from that of a normal to a principal surface of a substrate,
a transmitting portion and a reflecting portion are disposed on said substrate, and
a voltage applied to the liquid crystal in said transmitting portion is different from that applied to the liquid crystal in said reflecting portion.

14. The electronic apparatus according to claim 13, wherein in a phase of black display, a voltage equal to or higher than a threshold value at which an orientation of the liquid crystal changes is applied to said reflecting portion, and either a voltage equal to or lower than the threshold value or no voltage is applied to said transmitting portion,
while in a phase of black display, a voltage equal to or higher than the threshold value is applied to said transmitting portion, and either a voltage equal to or lower than the threshold value or no voltage is applied to said reflecting portion.

15. The electronic apparatus according to claim 14, wherein in the phase of the black display, a direction of the orientation of the liquid crystal in said transmitting portion agrees with a direction of an absorption axis of one of said first polarizing plate and said polarizing plate, and
a direction of the orientation of the liquid crystal in said reflecting portion is different from each of directions of the absorption axes of said first polarizing plate and said second polarizing plate,
while in the phase of the white display, a direction of the orientation of the liquid crystal in said reflecting portion agrees with a direction of an absorption axis of one of said first polarizing plate and said second polarizing plate, and
a direction of the orientation of the liquid crystal in said transmitting portion is different from each of directions of the absorption axes of said first polarizing plate and said second polarizing plate.

16. The electronic apparatus according to claim 15, wherein said first polarizing plate and said second polarizing plate are disposed in a cross nicol state, and in the phase of the black display, the liquid crystal layer in said reflecting portion delays a phase of a linearly-polarized light by λ/4.

17. The electronic apparatus according to claim 13, wherein said substrate includes a first substrate and a second substrate, the liquid crystal is disposed between said first substrate and said second substrate, a transmitting portion electrode is formed in said transmitting portion, a reflecting portion electrode is formed in said reflecting portion, and relative voltages applied to said transmitting portion electrode and said reflecting portion electrode, respectively, are different from each other.

18. The electronic apparatus according to claim 17, wherein said transmitting portion electrode includes a transmitting portion pixel electrode and a transmitting portion common electrode, said reflecting portion electrode includes a reflecting portion pixel electrode and a reflecting portion common electrode, a common voltage is applied to each of said transmitting pixel electrode and said reflecting portion pixel electrode, and different voltages are applied to said transmitting portion common electrode and said reflecting portion common electrode, respectively.

19. The electronic apparatus according to claim 17, wherein said transmitting portion electrode includes a transmitting portion pixel electrode and a transmitting portion common electrode, said reflecting portion electrode includes a reflecting portion pixel electrode and a reflecting portion common electrode, a common voltage is applied to each of said transmitting portion common electrode and said reflecting portion common electrode, and different voltages are applied to said transmitting portion pixel electrode and said reflecting portion pixel electrode, respectively.
